(19) United States
(12) Patent Application Publication
(10) Pub. No.: US 2014/0019086 A1
(43) Pub. Date: Jan. 16, 2014

(54) Three-Dimensional Modeling

(71) Applicant: David Charles Gregg, San Diego, CA (US)

(72) Inventor: David Charles Gregg, San Diego, CA (US)

(73) Assignee: CITIZENRE CORPORATION, San Diego, CA (US)

(21) Appl. No.: 13/549,977

(22) Filed: Jul. 16, 2012

(51) Int. Cl. G06F 15/00; H04W 80/00

(52) U.S. Cl. 702/152; 455/41.2; 702/150

(57) ABSTRACT

Methods, computer readable media, and apparatuses for providing information about a home, building, or other structure are presented. In certain aspects, a user may interact with a user device in order for the system to determine various characteristics about the structure. In some arrangements, the characteristics may be relevant to solar power installation. For example, a user may interact with an application executing on the user device to provide another computing system with data allowing the computing system to calculate one or more three-dimensional space locations for a characteristic such as roof size or tilt. The characteristic may be calculated as a function of the locations and a known geometric configuration of a sensor unit in communication with the user device.

### TECHNICAL FIELD

Aspects of the disclosure generally relate to computing devices, systems, and computer software, and user interfaces. Additionally, one or more aspects of the disclosure generally relate to devices, systems, and software that may be used by various different users for designing and installing solar panel layouts.

### BACKGROUND

Installations of equipment, such as solar panels, may be configured as free standing installations or may be installed onto various types of structures. In particular, solar panel installations may include multiple different components, such as, for example, frames, inverters, batteries, and the solar panels themselves. Various environmental considerations may affect the manner in which the equipment is designed, installed, used and maintained. For example, the size and tilt of the installation area, the presence of any objects within the installation area (e.g., roof vents and skylights), and the presence of object blocking sunlight may be relevant to choices made during the design, installation, use and maintenance of a solar panel installation. Thus, there remains an ever present need to more efficiently, quickly and accurately gather and estimate environmental characteristics, such as those that affect the design, installation, use and maintenance of equipment installations.

### BRIEF SUMMARY

The following presents a simplified summary of the disclosure in order to provide a basic understanding of some aspects. It is not intended to identify key or critical elements of the disclosure or to delineate the scope thereof. The following summary merely presents some concepts of the disclosure in a simplified form as a prelude to the more detailed description provided below.

Aspects described herein relate to methods, computer readable media, and apparatuses for use in designing, installing, using and maintaining equipment installations. In some arrangements, a user device and a sensor unit may communicate with each other in order to inform the sensor unit with data that can be used to determine a current location of the user device in three-dimensional (3-D) space. Based on the current location of the user device, various environmental characteristics about a home, building, structure, or object near the structure may be determined. For example, the sensor unit may be comprised of multiple sensors and each sensor may receive an acknowledgement to a signal from the user device. A distance to the user device from each sensor may be calculated based on the difference in time between transmission of the signal and receipt of the acknowledgement to the signal at each sensor. A three-dimensional location for the user device may also be calculated as a function of distances to the user device from each sensor and the known geometric configuration of the sensor unit. Based on this 3-D location, an environmental characteristic of the structure may be determined.

Further aspects relate to methods, computer readable media, and apparatuses for use in designing, installing and maintaining solar panel equipment. For example, by implementing one or more aspects of the disclosure, environmental characteristics relevant to solar panel equipment and installations being designed, installed, used or maintained on a structure may be determined. For example, a user device, a sensor unit and other computing devices may be operated on the site of the structure. By such operation, characteristics such as roof size, roof tilt, locations and sizes of various objects on the roof, and locations and sizes of various objects near the structure may be determined.

Additional aspects relate to an apparatus used to simulate a three-dimensional Cartesian coordinate system. For example, an apparatus may be comprised of three sensors. Each sensor may be arranged such that it simulates one of the axes of the three-dimensional Cartesian coordinate system. Each sensor may be attached to a shaft of a known length and each shaft may be orthogonal to each other.

The details of these and other embodiments of the present disclosure are set forth in the accompanying drawings and the description below. Other features and advantages will be apparent from the description and drawings, and from the claims.

### BRIEF DESCRIPTION OF THE DRAWINGS

The present disclosure is illustrated by way of example and not limited in the accompanying figures in which like reference numerals indicate similar elements and in which:

FIG. 1 is a block diagram showing an illustrative example of a network environment in which various aspects of this disclosure may be implemented.

FIG. 2A illustrates an example hardware platform on which various elements described herein can be implemented.

FIG. 2B illustrates an example mobile computing device that may be used in a network environment according to various aspects described herein.

FIGS. 3A and 3B illustrate example methods for determining environmental characteristics according to various aspects described herein.

FIGS. 4A and 4B illustrate views of an example embodiment of a sensor unit according to various aspects described herein.

FIG. 5 illustrates an example process for determining environment characteristics related to a solar panel installation according to various aspects described herein.

FIG. 6 is an example environmental view where various aspects described herein may be performed.

### DETAILED DESCRIPTION

Some embodiments may be described in the context of a network providing services to user devices over various networks using one or more protocols. The disclosure is not limited to any particular type of network or networks using a specific type of communication medium or to a specific set of communication protocols.

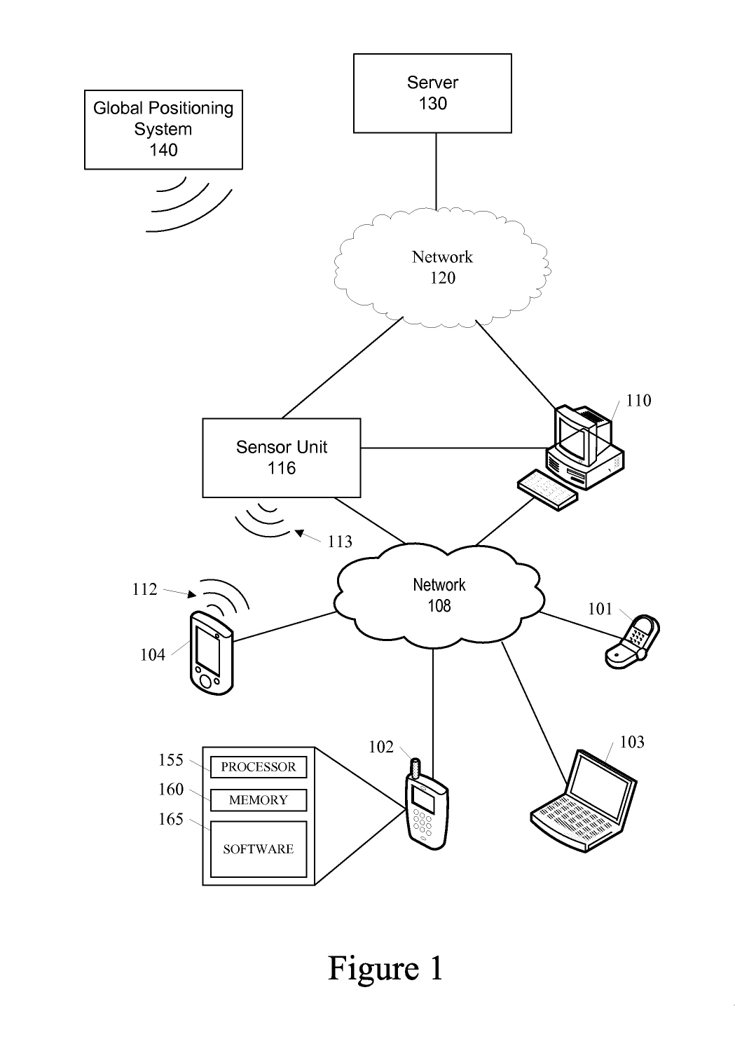

FIG. 1 is a block diagram showing an illustrative example of a network environment in which various aspects of this disclosure may be implemented. In the embodiment illustrated in FIG. 1, the network environment may include a number of computers and electronic devices (also generally referred to as user devices), including mobile phone 101, mobile communication device 102, personal digital assistant (PDA) or mobile computer 104, laptop computer 103, and the like. Other types of user devices include a smart phone or some device that combines of the above computing devices. Various other computing devices may be included in the network environment, such as, for example, computer 110, which may be a desktop, personal computer, laptop or similar device, and server 130. Other components of the network environment may include a sensor unit 116 and a global positioning system (GPS) 140. Various devices of the network environment (e.g., computer 110, user devices 101-104, sensor unit 116) may be configured to receive data from, or send data to, global positioning system 140.

The various devices and components of the network environment may communicate with one another and with other devices throughout the network environment using one or more networks, such as network 108 and 120. Network 108 and 120 may each include wired and wireless connections and network elements, and connections over the network may include permanent or temporary connections. Communication through the network environment is not limited to the illustrated devices and may include additional mobile or fixed computing devices.

Although network 120 and 108 are each shown as a single network in FIG. 1 for simplicity, networks 120 and 108 may include multiple networks that are interlinked so as to provide internetworked communications. Such networks may include one or more private or public packet-switched networks such as, for example, a local-area network (LAN) (e.g., a company intranet), a metropolitan area network (MAN), or a wide area network (WAN) (e.g., the Internet or World Wide Web). Such networks may also include a short or medium range wireless communication connection (e.g., Bluetooth®, ultra wideband (UWB), infrared, WiBree, wireless local area network (WLAN) according to one or more versions of Institute of Electrical and Electronics Engineers (IEEE) standard no. 802.11). Various other networks and network components may be included in such networks, such as one or more private or public circuit-switched networks (e.g., a public switched telephone network), a cellular network configured to facilitate communications to and from user devices, a satellite network, or a high-speed wireless data network. The various computing devices throughout the network environment may use various communication protocols such as Internet Protocol (IP), Transmission Control Protocol (TCP), Simple Mail Transfer Protocol (SMTP) among others known in the art.

User devices 101-104 may be configured to interact with each other or other devices, such as computer 110 and sensor unit 116. In one example, mobile communication device 102 may include software 165 that is configured to coordinate the transmission and reception of information to and from sensor unit 116 or computer 110. In one arrangement, software 165 may include application or server specific protocols for maintaining connections to and requesting/receiving data from sensor unit 116 and/or computer 110. Further, in some variations, software 165 may include an application and/or a user interface that is configured to be interactive with a user of the device. Software 165 may be stored in computer-readable memory 160 such as read only, random access memory, writeable and rewriteable media and removable media in device 102 and may include instructions that cause one or more components—for example, processor 155, a transceiver, and a display—of device 102 to perform various functions and methods including those described herein. While mobile communication device 102 is illustrated as including a processor 155, memory 160 and software 165, it should be recognized that other devices (e.g., user device 101, 103 and 104) may also include similar components.

Additionally, user devices 101-104 may be configured to directly interact with each other or other devices. In one example, mobile computer 104 may directly communicate with sensor unit 116 (or computer 110) to send/receive data (e.g., via a Bluetooth® connection), as shown by wireless communication 112. Accordingly, the sensor unit 116 (or computer 110) may also directly communicate with user devices 101-104 to send/receive data, as shown by wireless communication 113. In some variations, to facilitate the direct communication, sensor unit 116, computer 110 and user devices 101-104 may be located near each other in a certain geographic region (e.g., at an equipment installation site).

The network environment may include one or more servers, such as server 130. In some instances, the servers may be geographically dispersed (e.g., physically located in different geographic regions, countries, states, etc.) from sensor unit 116, computer 110 and user devices 101-104 (e.g., at a company's office). Each of the servers may be a file server, application server, web server, or the like. In some variations, the servers may be configured to provide services to the other devices of the network environment, such as data storage services, data processing services, or authentication services.

In some arrangements, server 130 may be configured to retrieve data from various databases, such as: (1) an internal customer database maintained at the server 130 which stores names, addresses, and account information (e.g., current and recommended solar panel layouts, etc.) for customers and potential customers, (2) an external weather database maintained by an independent weather service that can be accessed by the server 130 over the Internet that stores climate data (e.g., total and peak sun hours, temperature, precipitation, wind data, etc.) for different geographic regions, (3) a secure external database maintained by a local governmental entity that stores building codes and other regulatory data for neighborhoods and buildings within its locality, and (4) a parts and labor inventory database, which may be comprised of one or more internal or external servers that are accessible to the server 130 (e.g., over the Internet and/or via secure network connections) that stores information regarding the availability of solar panel component parts and materials (e.g., panels, frames, inverters, batteries, etc.), and additional information on labor availability (e.g., contractor schedules, etc.) to allow the server 130 to assist in scheduling installations of selected solar panel layouts.

Additionally, user devices 101-104, sensor unit 116 and computer 110 may be used by specially trained operators that design, install, or maintain equipment installations, such as solar panel installations. In certain examples, user devices 101-104, sensor unit 116, and computer 110 may be used in the field to provide direct information about a home, building, or other structure(s) at a location. The specifics of the information may be dependent on the type of equipment being designed, installed, used or maintained (e.g., information for solar panel installation may include such characteristics as roof pitch or tile, roof size, and other characteristics relevant to solar panel installation). In some embodiments, the information may be transmitted or otherwise transferred to the server 130 for storage and use in creating or modifying an equipment installation plan for the location. Additional details of providing direct information about a home, building, or other structure(s) will be discussed below.

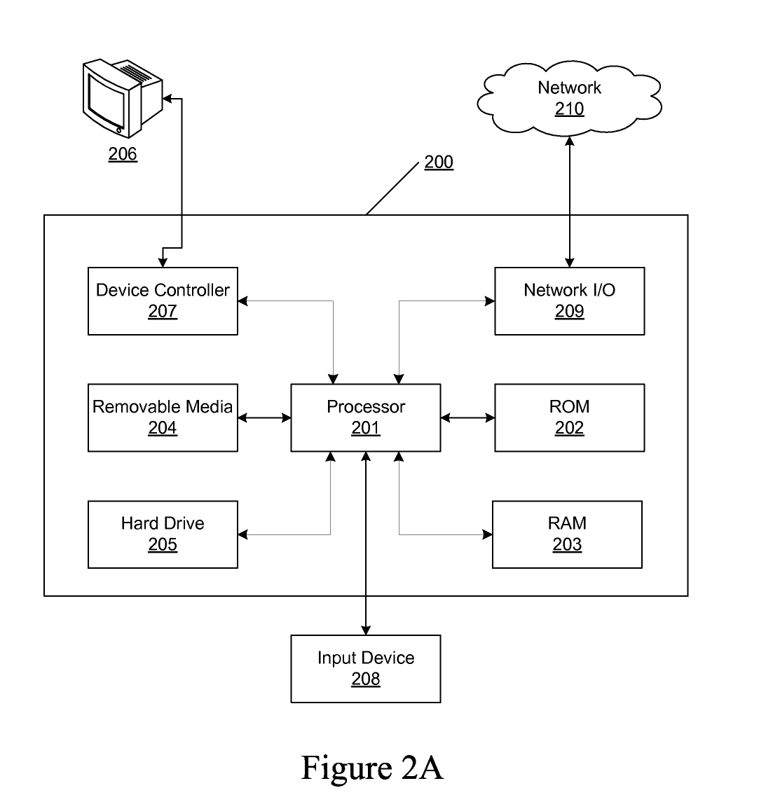

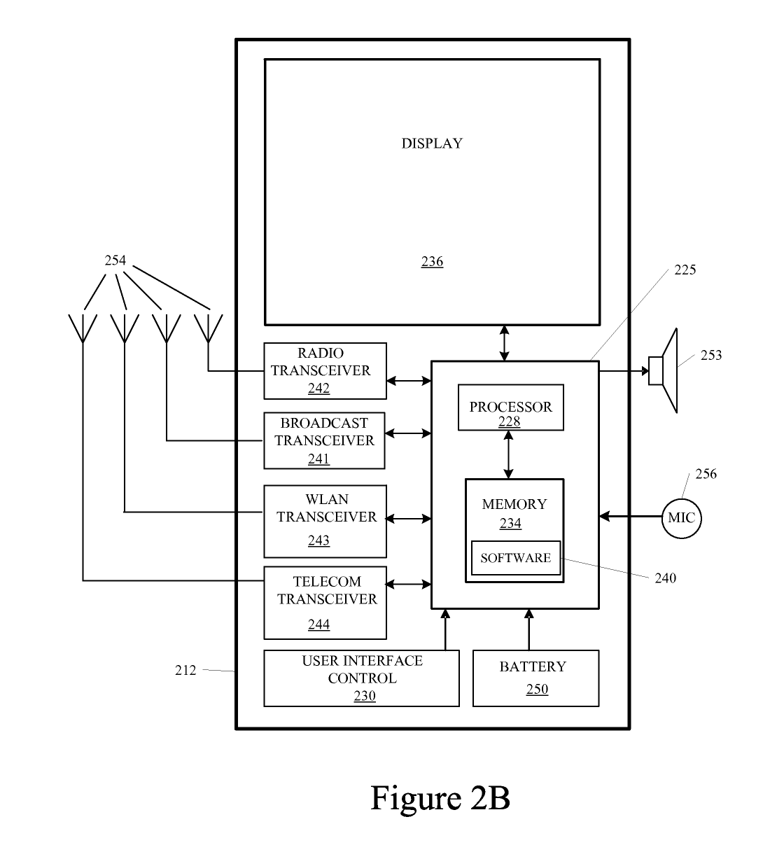

FIG. 2A illustrates an example hardware platform on which various elements described herein can be implemented, such as the various computing devices illustrated in FIG. 1 (e.g., computer 110, user devices 101-104, sensor unit 116). The computing device 200 may include one or more processors 201, which may execute instructions of a computer program to perform any of the features described herein. The instructions may be stored in any type of computer-readable medium or memory, to configure the operation of the processor 201. For example, instructions may be stored in a read-only memory (ROM) 202, random access memory (RAM) 203, removable media 204, such as a Universal Serial Bus (USB) drive, compact disk (CD) or digital versatile disk (DVD), floppy disk drive, or any other desired electronic storage medium. Instructions, one or more operating systems, and/or one or more applications may also be stored in an attached (or internal) hard drive 205. The computing device 200 may include one or more output devices, such as a display 206 (or an external television), and may include one or more output device controllers 207, such as a video processor. There may also be one or more user input devices 208, such as a remote control, keyboard, mouse, touch screen, microphone, etc. The computing device 200 may also include one or more network interfaces, such as input/output circuits 209 (such as a network card) to communicate with an external network 210. The network interface may be a wired interface, wireless interface, or a combination of the two. In some embodiments, the interface 209 may include a modem (e.g., a cable modem), and network 210 may include the communication lines of a network illustrated in FIG. 1, or any other desired network.

The FIG. 2A example is an illustrative hardware configuration. Modifications may be made to add, remove, combine, divide, etc. components as desired. Additionally, the components illustrated may be implemented using basic computing devices and components, and the same components (e.g., processor 201, storage 202, user interface, etc.) may be used to implement any of the other computing devices and components described herein.

FIG. 2B illustrates an example mobile computing device that may be used in a network environment, such as the network environment of FIG. 1. Various mobile computing devices described herein (e.g., mobile phone 101, mobile communication device 102, PDA 104 of FIG. 1) may implement various elements of the example mobile computing device illustrated in FIG. 2B. Mobile device 212 may include a controller 225 connected to a user interface control 230, display 236 and other elements as illustrated. Controller 225 may include one or more processors 228 and memory 234 storing software 240, such as an operating system and/or one or more applications. Mobile device 212 may also include a battery 250, speaker 253 and antenna 254. The mobile device 212 may include user interface circuitry, such as user interface control 230. User interface control 230 may include controllers or adapters, and other circuitry, configured to receive input from or provide output to a keypad, touch screen, voice interface. Input can be received, for example, via microphone 256, function keys, joystick, mouse and the like. The user interface circuitry, user interface software and operating system may be configured to facilitate user control of at least some functions of the mobile phone though use of a display. Display 236 may be configured to display at least a portion of a user interface of the mobile device. The display may be configured to facilitate user control of at least some functions of the mobile device. Additionally or alternatively, mobile device 212 may be configured to receive, decode and process transmissions through various transceivers, such as broadcast transceiver 241, FM/AM Radio transceiver 242, wireless local area network (WLAN) transceiver 243, and telecommunications transceiver 244.

Although the above description of FIG. 2B generally relates to a mobile device (e.g., mobile devices 101, 102 and 104 of FIG. 1), other devices or systems may include the same or similar components and perform the same or similar functions and methods. For example, a stationary computer (e.g., laptop computer 103 of FIG. 1) may include the components or a subset of the components described above and may be configured to perform the same or similar functions as mobile device 212 and its components.

One or more aspects of the disclosure may be embodied in computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired in various embodiments. In addition, the functionality may be embodied in whole or in part in firmware or hardware equivalents such as integrated circuits, field programmable gate arrays (FPGA), application-specific integrated circuits (ASIC), and the like. Particular data structures may be used to more effectively implement one or more aspects, and such data structures are contemplated within the scope of computer executable instructions and computer-usable data described herein.

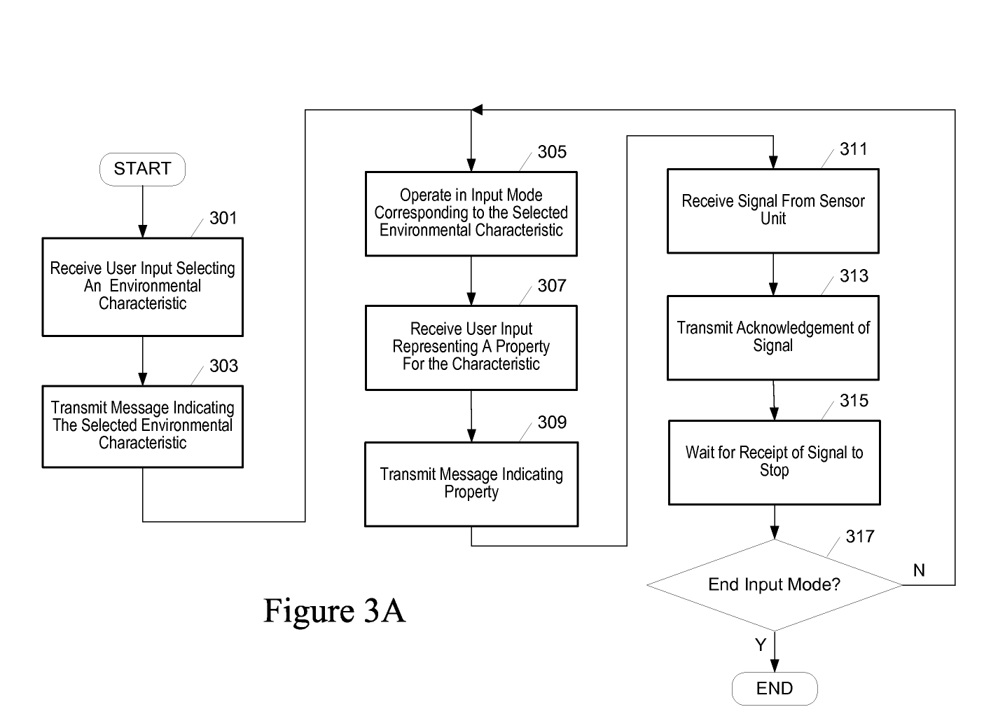

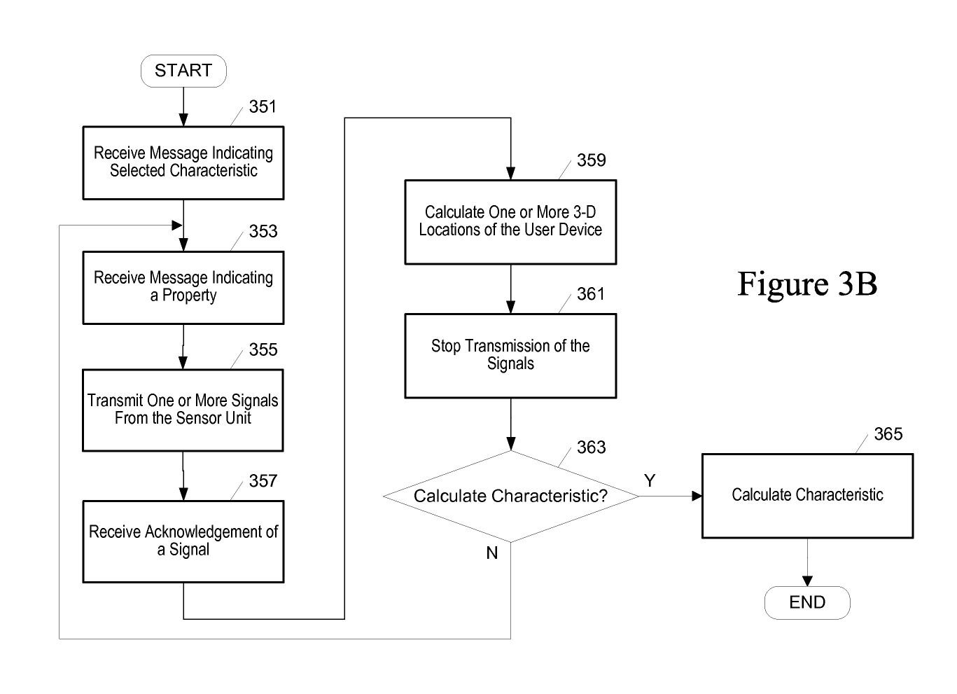

As discussed above, one or more aspects of this disclosure relate to providing information about a home, building, or other structure(s), such as various environmental characteristics. FIGS. 3A and 3B illustrate example methods for determining environmental characteristics according to various aspects described herein. In particular, FIG. 3A may be performed by a user device, such as user devices 101-104 of FIG. 1. FIG. 3B may be performed by one or more computing devices, such as sensor unit, a user device, and/or computer 110 of FIG. 1.

Referring now to FIG. 3A, at step 301, user input may be received that selects an environmental characteristic. For example, an application may be executing on a user device that provides a user interface. One or more of the interface's display screens may allow a user to view different types of characteristics that are relevant to the equipment, highlight or otherwise identify one of the different types, and then press a button on the user device (e.g., a physical button or a button displayed on a touch screen) to select the desired characteristic.

Various environmental characteristics may be available for a user to select, and generally, the set of available characteristics may be dependent on the type of equipment being designed, installed, used or maintained. For example, characteristics that are relevant to the installation of a satellite antenna may be different than the characteristics that are relevant to the installation of solar panels (though some characteristics may be shared), and the application executing on the user device may be designed to include only characteristics that are relevant to a particular type of equipment installation. In some variations, the application may allow for a user to first select the type of equipment being designed, installed, used or maintained, and the characteristics available for selection may be changed in accordance with the selected type of equipment (e.g., list only the characteristics relevant to the chosen equipment).

In certain examples, the equipment being designed, installed, used or maintained may be solar panels. The user device may be used on-site at the location for the solar panel installation. Environmental characteristics relevant to solar panel installation may include roof pitch or tilt; roof size; locations and sizes of various objects on the roof, such as, for example, chimneys, roof vents, antennas, satellite dishes, electrical line drop, or skylights; locations and sizes of various objects at the location (e.g., trees or adjacent structures), roof material, age of the roof material, age of a tree, type of a tree, and other characteristics that are relevant to the installation of solar panel systems. Such characteristics may allow for a more optimal component selection or layout. For example, particular solar panels may require a minimum roof size and if the roof size characteristic is not of sufficient size, a designer would know that such panels could not be installed on the structure's roof. In one particular example, smaller wattage solar panels may fit on certain roof sizes, but larger wattage roof sizes may require larger roof sizes. As another example, alternating current solar panels may be able to fit on smaller roof sizes and/or roofs with greater tilt than direct current solar panels.

At step 303, a message may be transmitted to indicate the selected environmental characteristic. For example, a message may be transmitted to a sensor unit (e.g., sensor unit 116 of FIG. 1) or other on-site computer (e.g., computer 110 of FIG. 1), and the message may identify the characteristic selected at step 301. In some arrangements, this message may be sent via a Bluetooth® connection, or other wireless connection.

At step 305, an input mode corresponding to the selected environmental characteristic may be operated. In some variations, each characteristic may be defined by various properties and the manner in which the properties are determined may vary. For example, properties defining roof size (e.g., the location of the corners of the roof) may be different than the properties for determining a location of a roof vent. Accordingly, each of the environmental characteristics may correspond to its own input mode.

Additionally, in some variations, some characteristics may be combined into a single input mode. As one example, roof size and roof tilt may be determined by the same properties (e.g., determined based on locations along the perimeter of the roof). Accordingly, when the selected characteristic is roof size or roof tilt, the input mode may be a mode for roof size and roof tilt.

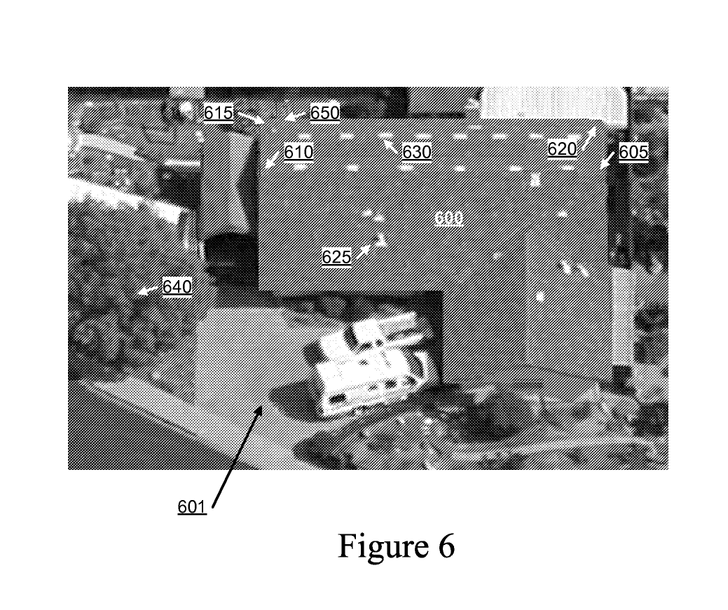

At step 307, user input representing a property for the characteristic may be received. For example, the application may provide an indication of what property to enter, and the user may take the appropriate steps to enter the required property. While additional details will be discussed in connection with FIG. 6, one example may be for entry of roof size and tilt. While operating the input mode for roof size and tile, the interface may display an indication that locations along the roof's perimeter may now be input. To enter a location, a user may move to a location along the perimeter (e.g., a corner of the roof) and press a button to indicate that the device is at a location along the perimeter.

At step 309, a message identifying the property may be transmitted. In some embodiments, the message may be transmitted to the sensor unit or other on-site computer. The message may include information that depends on the property or selected characteristic. For example, the message may include a code-word or other identifier to identify the property to the destination of the message (e.g., an identifier that identifies this message as being for a location along a roof perimeter). The message may also include data describing the property (e.g., the species of tree, an estimated height of the tree, etc.). In some arrangements, this message may be sent via a Bluetooth® connection, or other short-range wireless connection.

At step 311, a signal may be received from a sensor unit. In some arrangements, the received signal may be responsive to the message sent at step 309. While details of this signal will be discussed below in connection with FIG. 3B, the signal may include a number or some other identifier that uniquely identifies the received signal. The signal may also include one or more time stamps for synchronizing the communication between the devices. At step 313, an acknowledgement of the signal may be transmitted to the sensor unit. In some variations, the acknowledgement may include the number or identifier of the signal received at step 311. The acknowledgement may also include one or more time stamps that may be used for synchronizing the communication between the devices. Additionally, in some arrangements, the signal of step 311 may be one of a plurality of signals received from the sensor unit (e.g., the sensor unit may repeatedly send the signal). Therefore, at optional step 325, the device may wait until receipt of the signal has stopped. For example, upon receiving each instance of the signal, a timer may be reset and if the timer reaches a threshold value before the next signal is received, the method may proceed to step 317. In some arrangements, the signal may be received and the acknowledgement may be sent via a Bluetooth® connection, or other short-range wireless connection.

Additionally, some properties, such as the locations along the perimeter of the roof, may be defined by the current location of the user device. In some arrangements, the sensor unit may be configured to calculate the location of the user device, and the communication between the user device and sensor unit shown at steps 311 and 313 may inform the sensor unit with data that it can use to calculate the location of the user device in 3-D space. Details of this determination will be discussed below.

At step 317, it may be determined whether to end the input mode. In some embodiments, an input mode may be ended in response to specific user input. For example, a user may press a button that causes the input mode to end. Additionally, in some arrangements, some characteristics may require a particular number of properties be entered. Accordingly, an input mode may be ended upon entering all properties for the characteristic corresponding to the input mode. For example, an input mode for a roof vent may require only entry of the location of the roof vent (e.g., the application returns to the display screen allowing a user to select a desired environmental characteristic). Once steps 305-315 have been performed for the location of the roof vent, the method may end. If the input mode is to continue (e.g., not end), the method may proceed to step 305 to continue entry of properties under the input mode.

Therefore, steps 305-315 represent an iterative process for entering properties under the input mode. Continuing the above example where the user is entering locations along the perimeter of the roof while operating in an input mode for roof size and tilt, steps 305-315 may be repeated until the input mode is ended (e.g., canceled by a user or ended automatically upon entry of all the characteristic's properties). Accordingly, a user may continue moving to various locations along the perimeter, and press a button at each location.

In some variations, upon determining to end the input mode, a message indicating that the input mode is ending may be transmitted (e.g., to the sensor unit or on-site computer). Further, in some variations, the message indicating that the input mode is ending may be transmitted depending on the type of characteristic corresponding to the current input mode. For example, such a message may be transmitted for a roof size or tilt characteristic because, in some arrangements, a user may be able to enter any number of locations along the perimeter of the roof. However, such a message may not be transmitted for a location of a roof vent because, in some embodiments, only one location may be required to complete the input mode for the roof vent.

Additionally, at any time, an error message may be received from the sensor unit or the on-site computer. In some variations, an error message may cause certain actions to occur. For example, an error message may cause the input mode to be reset and the user may have to repeat entry of the properties for that characteristic. As another example, an error message may cause the input mode to direct the user to repeat entry of the most recent property. As yet another example, an error message may cause another acknowledgement to be sent (e.g., acknowledging the most recently received signal). The error messages may include an identifier to allow the user device to identify what type of error message has been received and, therefore, take the appropriate action in response to the error message.

Referring now to FIG. 3B, at step 351, a message indicating the selected environmental characteristic may be received. In some arrangements, this message may be sent from a user device and may have been transmitted from the user device at step 303. Accordingly, the message may include an identification of a characteristic, such as roof size, roof tilt, etc. This message may be used to identify what properties are to be subsequently expected. In some variations, a database may be queried with the identifier of the message to retrieve a listing of valid properties for that characteristic. Additionally, rules for calculating or otherwise determining the characteristic may also be retrieved. For example, one rule for calculating a roof size may define a minimum number of locations along the perimeter that are required to calculate the roof size (e.g., 3 points).

At step 353, a message indicating a property may be received. This message may be received from a user device and may have been transmitted from the user device at step 309. In some arrangements, the code-word or identifier included in this message may be compared against the list of valid properties for the characteristic. If the code-word or identifier does not match, an error message may be generated and transmitted to the user device.

At step 355, one or more signals may be transmitted from the sensor unit. In some embodiments, the sensor unit may repeatedly send out a signal (e.g., every tenth of a second). Each iteration of the signal may be provided with its own number or other identifier that uniquely identifies it from other signals sent while step 355 is being performed. For example, a counter may be incremented for each signal transmission and the current value of the counter may be assigned to a signal prior to transmission. As another example, a time stamp, time code or time code hash may be assigned to a signal prior to transmission.

At step 357, an acknowledgement of a signal may be received. In some arrangements, this acknowledgement may be sent from the user device at step 309. Additionally, the acknowledgement may include the number or identifier for the signal that the acknowledgement is responsive to. Further, the acknowledgement may include the original time stamp of the signal transmitted at step 355 and a second time stamp added by the user device when the user device receives the signal transmitted at step 355. The sensor unit may also add a third time stamp to the acknowledgement, which indicates the receipt time of the acknowledgement at the sensor unit.

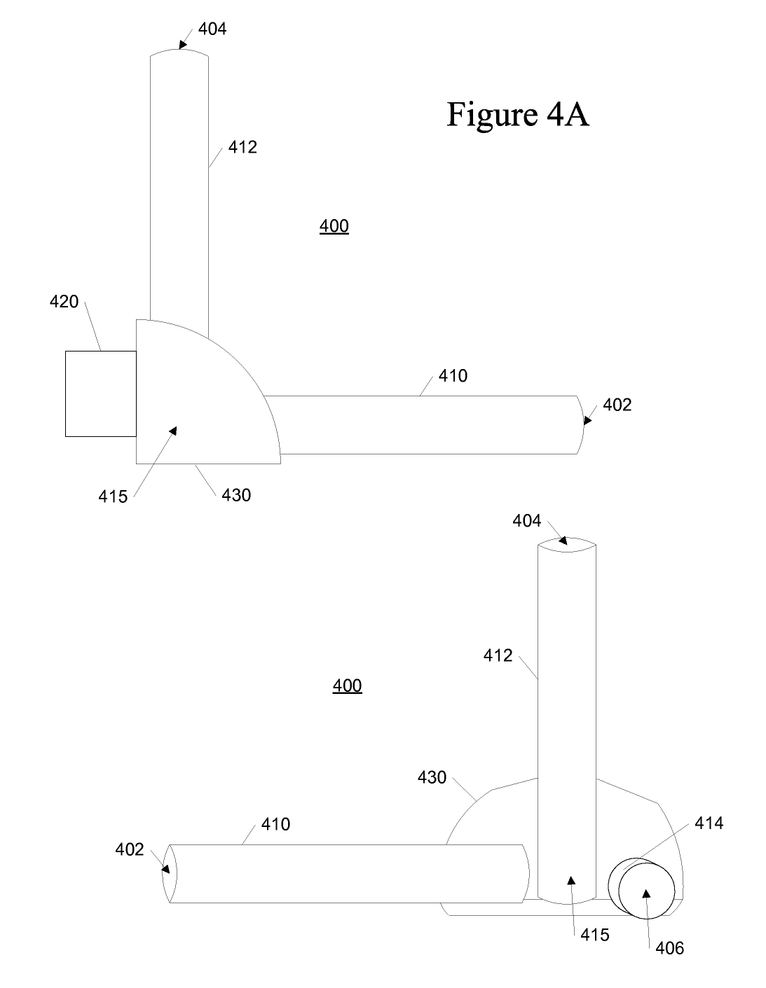

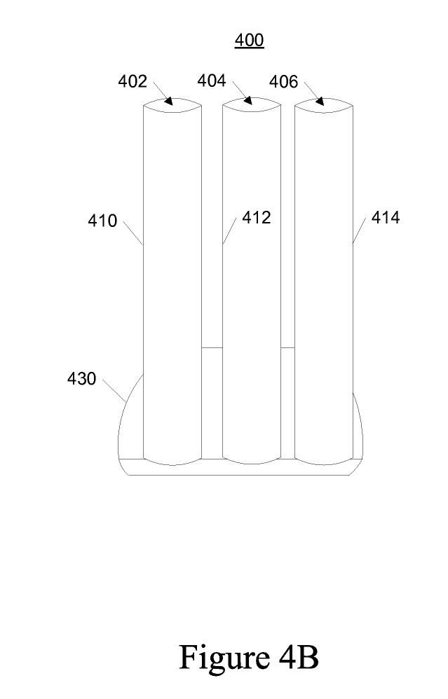

Further, in some embodiments, the sensor unit may include a configuration of multiple sensors. FIGS. 4A and 4B illustrate views of an example embodiment of a sensor unit. In particular, FIGS. 4A and 4B illustrate an example sensor unit where sensors are in a configuration to simulate a 3-D Cartesian coordinate system. As illustrated, sensor unit 400 includes three sensors (e.g., sensors 402, 404, and 406). Each sensor may be located at or near the end of a shaft (e.g., sensor 402 is near the end of shaft 410, sensor 404 is near the end of shaft 412, and sensor 406 is near the end of shaft 414). In some variations, a sensor may be a Bluetooth receiver/transmitter, or some other suitable radio frequency receiver/transmitter. Each sensor may be connected to electrical components within housing 420. The electrical components may process data received at the sensors, process data for transmission from the sensors, and/or process data for transmission to another computing device connected to sensor unit 400. For example, sensor unit 400 may be connected via a USB connector to the on-site computer (not shown). Sensor unit 400 may also be in communication with the on-site computer via Bluetooth or other wireless connection. In some arrangements, the electrical components may be configured to perform the 3-D location calculation, as described below. The sensor unit 400 may also include levels to indicate that sensors 402, 404 and 406 are in the correct position (e.g., sensor 402 and 46 are horizontal and sensor 404 is vertical). The sensor unit 400 may also include a compass to indicate the direction/orientation of the sensor unit. The sensor unit 400 may also include a global positioning receiver in order to determine a location of the sensor. Data from the levels, compass, and/or global positioning system may be communicated to a computer (e.g., the on-site computer, the user device, or a remote server) in order to record the known configuration of the sensor unit. Alternatively, a user may enter the data of the levels, compass, and/or global positioning system into a computer to record the known configuration of the sensor unit.

As illustrated in FIG. 4A, each sensor and shaft may be configured to simulate a particular axis of a 3-D Cartesian coordinate system. For example, shaft 410 with sensor 402 may simulate the X-axis, shaft 412 with sensor 404 may simulate the Z-axis, and shaft 414 with sensor 406 may simulate the Y-axis. Point 415 may be configured as the origin of the 3-D Cartesian coordinate system provided by the configuration of sensor unit 400, which may represent the intersection of the X, Y and Z axes of the 3-D Cartesian coordinate system. Further, each shaft may be of equal length (e.g., six inches each, 1 foot each, 3 foot each) and each shaft may be arranged such that they are orthogonal to each other. The length of each shaft may be communicated from the sensor (or input by a user) to a computer in order to further define the known configuration of the sensor unit.

Additionally, the various shafts of the sensor unit 400 may be rotatably fastened to support 430 of sensor unit 400. For example, the two views of FIG. 4A illustrate the sensor unit in an open or deployed configuration (e.g., where the shafts are arranged to simulate a 3-D Cartesian coordinate system). The view of FIG. 4B illustrates the sensor unit in a closed configuration. In some variations, the shafts of sensor unit 400 may be rotated or otherwise moved to and/or from the open or closed configuration manually.

Because the sensor unit includes multiple sensors, each sensor may receive the acknowledgement. However, each sensor may receive the acknowledgement at a slightly different time due to the configuration of the sensors and some being closer or farther from the user device. Therefore, at step 359, one or more 3-D locations of the user device may be calculated. This step may be performed by the sensor unit, the on-site computer, the user device, a remote server, or some combination thereof. In some arrangements, the sensor unit may transmit the data and/or messages used to calculate the 3-D locations (e.g., the acknowledgements and messages received in the prior steps) to the computing device responsible for calculating the 3-D location (e.g., transmit via a wireless or wired connection to the user device, on-site computer, or remote server). In some arrangements, the process of calculating the 3-D locations may begin by calculating an estimated distance to the user device from each sensor of the sensor unit. For example, upon receipt of an acknowledgment from a sensor, the time of transmission for the signal which the acknowledgement is responsive to may be identified (e.g., the signal with identifier “X” may be transmitted at 12:00:01) and the time of receipt for the acknowledgement may be identified (e.g., the acknowledgment with identifier “X” may be received at 12:00:01 by sensor 402 of sensor unit 400). The difference between these times may then be calculated and used to estimate the distance to the user device from the sensor. Additionally or alternatively, the acknowledgements may include one or more time stamps (e.g., each time stamp indicating a receipt time or a transmittal time of a message, such as a transmittal time from a sensor unit to a user device, a receipt time of a message at a user device, and a receipt time of a message at the sensor unit) and the differences between the time stamps may be used to calculate the distance to the user device from the sensor. Estimation of the distance to the user device may be repeated for each sensor in the sensor unit's configuration. Accordingly, with respect to sensor unit 400, three estimated distances may be calculated, a first distance to the user device from sensor 402, a second distance to the user device from sensor 404, and a third distance to the user device from sensor 406.

Upon calculating the estimated distance for each sensor, the estimated 3-D location of the user device may be calculated. For example, using the Pythagorean theorem and the geometric properties of the known configuration of the sensor unit (e.g., each sensor may be orthogonal to each other, the length of each sensor may be known, a location of the sensor from a GPS system may be known, the orientation from a compass may be known), the 3-D location of the user device may be calculated. In some variations, this 3-D location may be a set of three coordinates, each coordinate being for an axis of the 3-D Cartesian coordinate system formed by the sensor unit 400. Additionally, the 3-D location may be a distance or set of coordinates from a defined origin. In some arrangements, the origin may be defined as a central point of the sensor unit's configuration, such as origin point 415 of the 3-D Cartesian coordinate system formed by sensors 402, 404 and 406 of sensor unit 400. For example, the 3-D location may be estimated as (30, 15, 12), where 30 is the distance from the defined origin (e.g, point 415) along the X-axis (e.g., sensor 402), 15 is the distance from the defined origin along the Y-axis (e.g., sensor 406), and 12 is the distance from the defined origin along the Z-axis (e.g., sensor 404).

Other geometric processes may be used to estimate the 3-D location to the user device. For example, each distance from the sensors may be used as a radius of a sphere. A sphere for each distance may be modeled and the point where all the spheres intersect may be taken as the 3-D location of the user device. For example, with respect to sensor unit 400, three spheres may be modeled, a first sphere with a radius equal to the distance to the user device from sensor 402, a second sphere with a radius equal to the distance to the user device from sensor 404, and a third sphere with a radius equal to the distance to the user device from sensor 406. The point where these three spheres intersect may be taken as the 3-D location to the user device.

In some instances, the three spheres may not all intersect at a single point. In such instances, it may be determined whether the spheres intersect within a threshold distance of each other (e.g., determine whether the intersection of the first and second spheres is within a threshold distance of the intersection of the second and third spheres). If within the threshold distance, 3-D location may be determined based on the intersections of the spheres (e.g., taken as one of the intersection points, or taken as the average between the coordinates of the first and third sphere's intersection and the coordinates of the second and third sphere's intersection). In some variations, if the spheres do not all intersect at a point, or are otherwise not within a tolerance of each other, an error message may be generated or step 359 may be skipped and calculation of the 3-D location may be re-attempted upon receipt of a subsequent acknowledgement.

In some embodiments, the 3-D locations may be processed through GPS coordinates. In some embodiments, Global Positioning System (GPS) coordinates (e.g., latitude and longitude) may be determined and/or received (e.g., in conjunction with GPS 140 of FIG. 1), such as the GPS location of the site's location, the GPS location of the user device, or the GPS location of the sensor unit or on-site computer. Certain examples may determine the GPS location of the sensor unit and determine the GPS coordinates of each 3-D location by offsetting the GPS location of the sensor unit with the distance of each 3-D location (to result in a GPS coordinate offset for each 3-D location). Thus, by offsetting the GPS location of the sensor unit with the distance of each 3-D location, the GPS location of the roof may be determined. Additionally, GPS coordinates may be used when determining the estimated distance for each sensor.

At step 361, transmission of the signals from the sensor unit may be stopped. In some embodiments, this may be performed in response to receiving the acknowledgement at step 357 or upon completing calculation of the 3-D location. In arrangements, where another computing device calculates the 3-D location, the responsible computing device may transmit a signal to the sensor unit that causes the transmission of the signals to be stopped.

At step 363, it is determined whether to calculate the characteristic. This step may be performed by the same computing device that calculated the 3-D location (e.g., the sensor unit, the user device, the on-site computer, and/or the remote server). Alternatively, this step may be performed by a different computing device. For example, in embodiments where the user device or the on-site computer calculates the 3-D location, the user device or on-site computer may transmit data (e.g., the 3-D location(s) or other data) to a remote server that performs step 363. In some arrangements, this determination may include determining whether a rule is satisfied. For example, if a rule defines a minimum number of locations along the perimeter that are required to calculate the roof size (e.g., 3 points), it may be determined whether three 3-D locations (or three GPS coordinate offsets) have been calculated (e.g., step 359 has been repeated three times). If the rule is satisfied, the method may proceed to step 365. Otherwise the method may proceed to step 353 and wait for receipt of another property. In some variations, if there is too much delay between properties, an error message may be generated and transmitted to the user device.

Additionally, determining whether to calculate the characteristic may be based on a message received from the user device. For example, the method may determine to proceed to step 365 if a message indicating the input mode is ending has been received from the user device. Otherwise the method may proceed to step 353 and wait for receipt of another property.

At step 365, the characteristic may be calculated. This step may be performed by the same computing device that calculated the 3-D location and/or performed step 363 (e.g., the sensor unit, the user device, the on-site computer, and/or the remote server). Alternatively, this step may be performed by a different computing device. For example, in embodiments where the user device or the on-site computer calculates the 3-D location or performs step 363, the user device or on-site computer may transmit data (e.g., the 3-D location(s), an identifier of the characteristic to calculate, or other data) to a remote server that performs step 365. In some arrangements, the characteristic is based on all of the properties received for this characteristic. For example, with respect to a characteristic of roof size and/or tilt, the roof size and/or tilt may each be calculated based on the 3-D locations (e.g., the 3-D locations resulting from step 359). Each of the 3-D locations may represent a location along the perimeter of the roof. Accordingly, the roof size may be calculated by fitting a 2-D plane between the 3-D locations (e.g., by finding the 2-D plane that best fits the scatter of the 3-D locations) and calculating the area of the 2-D plane between all the 3-D locations. In certain examples, there may be four 3-D locations, with each 3-D location representing a corner of the roof. Therefore, the 2-D plane may be rectangular, with the corners of the rectangle defined by the four locations. Roof tilt may also be calculated from the 2-D plane by determining the angle between the plane and a horizontal plane As one example, the normal vectors for the 2-D plane and the horizontal plane may be determined, and the dot product of the two normal vectors may be determined. The dot product of the two normal vectors represents the angle between the 2-D plane and the horizontal plane (e.g., the tilt of the roof).

Additionally, in some embodiments, the characteristic may be used to define a model of the structure. For example, a model may be created as each characteristic of the structure is calculated. Accordingly, the model may include roof size, roof tilt, locations of various objects located on the roof, sizes of various objects located on the roof, locations of various objects near the structure, and sizes of various objects near the structure. In some variations, the model may define the characteristics relevant to equipment being designed, installed, used or maintained for the structure (e.g., a solar panel installation on the structure).

Upon calculating the characteristic and/or updating the model, the data may be stored and/or transmitted to another computing device. For example, the characteristic and/or model may be transmitted to the user device for display to the user or storage at the user device. The characteristic and/or model may also be transmitted to a remote server or a data repository at a central office (e.g., server 130 of FIG. 1) for storage and/or inclusion in a model of the installation site.

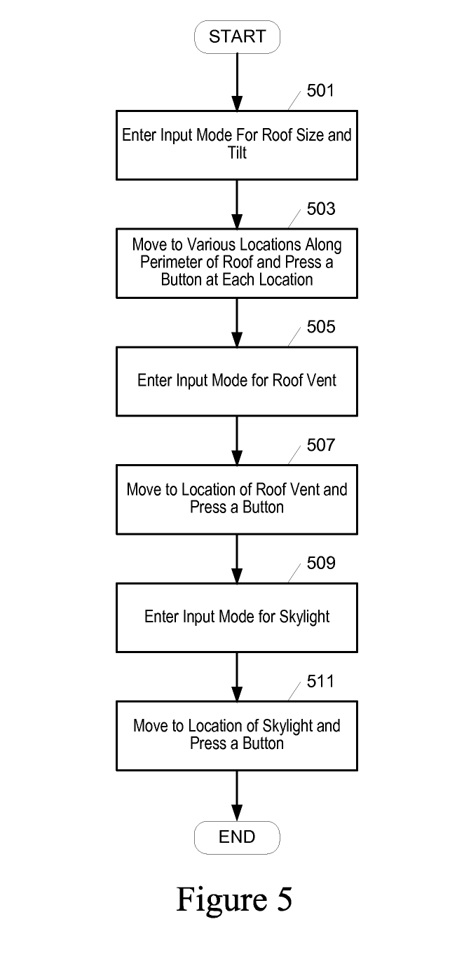

As discussed above, various aspects are related to determining characteristics relevant to solar panel installation. FIG. 5 illustrates an example process for determining environment characteristics related to a solar panel installation. In particular, FIG. 5 represents a process that a user may perform while using a user device to enter characteristics about a structure for a potential solar panel installation. Details of this process will be discussed in connection with FIG. 6, which provides an example environmental view that includes structure 600, a candidate for a potential solar panel installation.

In certain examples, a user (e.g., an employee of a solar panel installation company) may first arrange a sensor unit near or adjacent to a structure (e.g., structure 600). The sensor unit or the user supplies data describing the known configuration of the sensor unit (e.g., as described above, such as the length of the shafts, the orientation of the sensor unit, etc.). The sensor unit (e.g., sensor unit 116 of FIG. 1) may be in communication with an on-site computer (e.g., computer 110 of FIG. 1) and/or a mobile device (e.g., one of the user device 101-104 of FIG. 1). In some variations, the on-site computer may be located within a vehicle. Alternatively, the mobile device may perform the functions of the on-site computer; therefore, only the sensor unit and the mobile device are on-site. Point 601 of FIG. 6 shows an example location where the sensor unit and/or the on-site computer may be located. The user may take the mobile device and ascend to the structure's roof. The user may then begin to interact with the user device to model characteristics about the roof and/or structure. At step 501, a user may select an input mode for roof size and tilt. At step 503, the user may move to various positions along the perimeter of the roof and press a button on the user device at each location. The user device, the sensor unit, and the on-site computer may communicate with each other to estimate, and store, the 3-D location of each position along the roof. For example, the user may move first to position 605, then to position 610, then to position 615, and then to position 620, to provide the data for calculating the roof area and tilt. This process may be repeated for other sections of the roof. The roof size and tilt for the section of roof defined by positions 605, 610, 615 and 620 may also be calculated based on the 3-D locations of each position along the roof.

At step 505, the user may select an input mode for a roof vent. At step 507, the user may move to a location of a roof vent (e.g., position 625) and press a button on the user device. The user device, the sensor unit, and/or the on-site computer may communicate with each other to estimate, and store, the 3-D location of the roof vent. These steps may be repeated for other roof vents located on structure 600.

At step 509, the user may select an input mode for a skylight. At step 511, the user may move to a location of a skylight (e.g., position 630) and press a button on the user device. The user device, the sensor unit, and the on-site computer may communicate with each other to estimate, and store, the 3-D location of the skylight. These steps may be repeated for other skylights located on structure 600.

The user may enter into various other input modes to identify other characteristics of structure 600 or characteristics of objects surrounding structure 600. For example, a user may enter into an input mode for a tree and press a button when at point 640. As another example, a user may enter into an input mode for a chimney and press a button when at point 650.

Additionally, all of the entered characteristics may be transmitted to a remote server for storage and/or further processing. For example, the characteristics may be used by trained personnel to develop an installation plan for structure 600, such as, for example, by selecting the number of solar panels that will fit on the area of the roof, the type of panel suitable based on the characteristics of the structure and surrounding area, the location of the panels based on the characteristics of the structure and surrounding area, etc.

Additionally, numerous other embodiments, modifications and variations within the scope and spirit of the appended claims will occur to persons of ordinary skill in the art from a review of this disclosure.

We claim:

1. A method comprising:
receiving an acknowledgement to a signal at each sensor in a plurality of sensors, the plurality of sensors being arranged in a geometric configuration;
determining a difference in time between transmission of the signal and receipt of the acknowledgement to the signal at each sensor, resulting in a determined difference for each sensor;
calculating a distance from each sensor in the plurality of sensors based on the determined difference for each sensor, resulting in a plurality of distances;
calculating a three-dimensional location as a function of the plurality of distances and the geometric configuration; and
determining an environmental characteristic based on the three-dimensional location.

2. The method of claim 1, wherein the geometric configuration is a three-dimensional Cartesian coordinate system with each sensor in the plurality of sensors being one of the axes of the three-dimensional coordinate system, and the three-dimensional location is a distance from an origin of the three-dimensional Cartesian coordinate system.

3. The method of claim 1, wherein the acknowledgement to the signal is received from a user device via a short-range wireless connection.

4. The method of claim 1, further comprising:
receiving a message indicating the environmental characteristic;
retrieving a listing of valid properties for the environmental characteristic;
receiving a message indicating a property of the environmental characteristic; and
comparing the property to a listing of valid properties for the environmental characteristic.

5. The method of claim 4, wherein the environmental characteristic defines a characteristic of a structure or object near the structure, and the environmental characteristic is relevant to installation of solar panels on the structure.

6. The method of claim 5, wherein the environmental characteristic is roof tilt, roof size, location of a roof vent, location of a skylight, or location of a tree.

7. The method of claim 1, wherein calculating a distance from each sensor in the plurality of sensors based on the determined difference for each sensor includes calculating the distance from each sensor as a function of global positioning system (GPS) data.

8. The method of claim 1, further comprising:
modifying a model of a structure based on the environmental characteristic, the model defining characteristics relevant to a solar panel installation for the structure.

9. The method of claim 1, wherein calculating the distance from each sensor in the plurality of sensors based on the determined difference for each sensor is performed by a mobile device.

10. An apparatus comprising:
one or more processors; and
memory storing computer executable instructions configured to, with the one or more processors, cause the apparatus to:
receive a plurality of acknowledgements, each of the plurality of acknowledgments being received at a different sensor of a plurality of sensors, wherein the plurality of sensors are arranged in a geometric configuration;
determine a difference in time between transmission of a signal and receipt of each acknowledgment of the plurality of acknowledgements, resulting in a determined difference for each sensor;
calculate a distance from each sensor in the plurality of sensors based on the determined difference for each sensor, resulting in a plurality of distances;
calculate a three-dimensional location as a function of the plurality of distances and the geometric configuration; and
determine an environmental characteristic based on the three-dimensional location.

11. The apparatus of claim 10, wherein the geometric configuration is a three-dimensional Cartesian coordinate system with each sensor in the plurality of sensors being one of the axes of the three-dimensional coordinate system, and the three-dimensional location is a distance from an origin of the three-dimensional Cartesian coordinate system.

12. The apparatus of claim 10, wherein the acknowledgement to the signal is received from a user device via a short-range wireless connection.

13. The apparatus of claim 10, wherein the memory further stores computer executable instructions configured to, with the one or more processors, cause the apparatus to:
receive a message indicating the environmental characteristic;
retrieve a listing of valid properties for the environmental characteristic;
receive a message indicating a property of the environmental characteristic; and
compare the property to a listing of valid properties for the environmental characteristic.

14. The apparatus of claim 13, wherein the environmental characteristic defines a characteristic of a structure or object near the structure, and the environmental characteristic is relevant to installation of solar panels on the structure.

15. The apparatus of claim 14, wherein the environmental characteristic is roof tilt, roof size, location of a roof vent, location of a skylight, or location of a tree.

16. The apparatus of claim 10, wherein calculating a distance from each sensor in the plurality of sensors based on the determined difference for each sensor includes calculating the distance from each sensor as a function of global positioning system (GPS) data.

17. The apparatus of claim 10, wherein the memory further stores computer executable instructions configured to, with the one or more processors, cause the apparatus to:
modify a model of a structure based on the environmental characteristic, the model defining characteristics relevant to a solar panel installation for the structure.

18. An apparatus comprising:
a plurality of sensors arranged in a geometric configuration;
one or more processors;
memory storing computer executable instructions configured to, with the one or more processors, cause the apparatus to:
cause one or more of the plurality of sensors to repeatedly transmit a signal via a short-range wireless protocol; and
receive acknowledgements to the signal, wherein each of the plurality of sensors receives an acknowledgement via a short-range wireless protocol;
cause the plurality of sensors to cease repeatedly transmitting the signal.

19. The apparatus of claim 18, wherein the plurality of sensors includes three sensors arranged in a three-dimensional Cartesian coordinate system with each sensor being one of the axes of the three-dimensional Cartesian coordinate system.

20. The apparatus of claim 18, wherein the short-range wireless protocol is Bluetooth.

21. The apparatus of claim 18, wherein the memory further stores computer executable instructions configured to, with the one or more processors, cause the apparatus to:
calculate a distance from each sensor of the plurality of sensors to a source of an acknowledgement; and
calculate a distance from an origin of the geometric configuration as a function of the distance from each sensor.

22. A system, comprising:
a sensor unit arranged to be in communication with a user device at a solar panel installation site, wherein the solar panel installation includes a structure that includes a roof, and wherein the sensor unit is configured to calculate a three-dimensional location as a function of a distance between the sensor unit and the user device;
a user device, located at the solar panel installation site, configured to receive user input at the one or more locations along the structure's roof and transmit messages to the sensor unit causing the sensor unit to calculate one or more three-dimensional locations corresponding to the one or more locations along the structure's roof; and
a computing device in communication with the sensor unit configured to determine size or tilt of the roof as a function of the one or more three-dimensional locations corresponding to the one or more locations along the structure's roof.
